(19) United States
(12) Patent Application Publication
(10) Pub. No.: US 2004/0061334 A1
(43) Pub. Date: Apr. 1, 2004

(54) Plug-in connector for plumbing fixtures

(76) Inventor: Stefan Kruck, Roetenberg (DE)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/620,126

(22) Filed: Jul. 15, 2003

(30) Foreign Application Priority Data
Jul. 19, 2002 (DE) 10234206.7

(51) Int. Cl. F16L 17/00

(52) U.S. Cl. 285/360; 285/376; 285/401

(57) ABSTRACT

In order to attach an inlet line to a housing of a plumbing fixture such that it may be detached therefrom, it is proposed that a flange projecting radially beyond the end of the line having a rim that has a shape other than a circular shape be attached to the line in the vicinity of the end of the line. The flange, along with the end of the line, may be shifted to a certain angular orientation to the extent that it will be arranged behind the undercut in the axial direction. Rotating the end of the line, together with the flange, will then bring the flange into engagement with the undercut, which will prevent the end of the line from being withdrawn.

The invention is based on a plug-in connector for a plumbing fixture or a plumbing fixture having a plug-in connector.

Routing the inlet lines of plumbing fixtures installed on a wash basin or similar through the base of the plumbing fixture from below is known. Their inlet lines are frequently configured as separate pipes that are inserted into the base of the plumbing fixture from above. In the case of a known plumbing fixture (cf. German patent DE 3119313), its base incorporates a section that accommodates the water lines in a stepped bore. The inlet line, which has a bead that extends radially outward, is inserted into that lower section from above.

Connecting a pipe to a housing, into which the pipe may be inserted from below, where the pipe digs into the bore such that it will be held in place therein, is also known (cf. German patent DE 4026816).

The problem addressed by the invention is creating a means for connecting lines that have been inserted into, and pass through, the base of a plumbing fixture from below to the plumbing fixture, without need for using any tools, and will allow subsequently disconnecting them therefrom.

The invention solves that problem by proposing a plug-in connector having those features stated in claim 1. Other embodiments of the invention are covered by the dependent claims.

A plug-in bushing that, under some circumstances, may be a simple, cylindrical bore, is now formed in the plumbing fixture. A flange that may be oriented such that the end of the line may be inserted into the plug-in bushing when the flange has a certain angular orientation is arranged on the end of the line. The flange may subsequently be reoriented such that the end of the line remains in the plug-in bushing, but the flange can no longer be withdrawn therefrom. The end of the line will thus be securely held in place in the plug-in bushing and connected to the plumbing fixture. However, it may be subsequently withdrawn therefrom.

Under an elaboration on the invention, the undercut may be configured such that the line, along with the flange, may be rotated to the extent that withdrawal of the line from the bushing will be prevented. The undercut thus must be suitably dimensioned in order that, in accordance with this particular feature of the invention, the flange may be rotated through a sufficiently large angle.

In order to provide a connection of the end of the line that will be secure with respect to accidental disconnection, in accordance with an elaboration on the invention, it may be provided that the undercut and/or the flange are configured such that a wedging of either the flange or the line will occur the when the line, together with the flange, are rotated. The wedging may be chosen such that it cannot release itself.

One means for providing for a secure connection would be arranging that the undercut and the flange form a bayonet connector. Such bayonet connectors are self-securing.

The undercut, which is held in place by the flange, may, for example, be formed on one side of the end of the line only, in which case, it will be sufficient if the flange is also formed partway around the end of the line only, i.e., for example, partway around the circumference of the end of the line only. This approach may be sufficient to hold lines in place, provided that the ends of the lines are long enough.

However, it may, in particular, also be provided that the undercut is shaped such that it fully encircles the end of the line, where the shape of the lafter's perimeter is noncircular, i.e., extends beyond the end of the line to greater or less extents at various locations. However, even in this case, it may still be said that both the undercut and the flange encircle the end of the line.

According to the invention, the undercut may also be formed ahead of the plug-in bushing, which may be utilized to generate a clamping action in the same manner as in the case where the undercut is formed behind the opening in the plug-in bushing.

It may be provided that the plug-in bushing is formed in an adapter situated between a mixer cartridge and the housing of the plumbing fixture. Such adapters are usually present on plumbing fixtures that employ a mixer cartridge. The adapter generates the connections between the water inlet, the ports on the mixer cartridge, and the water outlet. It would thus be reasonable to form the plug-in bushing in such an adapter.

One approach to forming the undercut would be forming it in the housing of the plumbing fixture, i.e., to have it formed in part of the housing of the plumbing fixture, for example, on a rib extending inward, in which case, the undercut could also be arranged ahead of the plug-in bushing.

Another approach to forming the undercut would be to form it in the adapter.

In order to simplify manufacture, it may be provided that the ends of the undercut and/or the plug-in bushing in the adapter are open and will be closed when the adapter is inserted into the housing of the plumbing fixture, which would be easier to arrange, particularly if the adapter is fabricated from plastic.

The flange may be arranged directly on the end of the line, in which case, sealing may be provided by a seal resting on a face of the flange. It will also be feasible, and is preferred by the invention, to site the flange at a distance from the free end of the line, which would form a sort of “plug-in nipple” ahead of the flange that may be used to guide the end of the line into the plug-in bushing.

In particular, it may be provided that an axial force exerted by, for example, an elastic element, in particular, an elastomeric element, that is also capable of simultaneously providing a sealing function, for clamping the end of the line in the plug-in bushing may occur.

Other features, details, and benefits of the invention will be evident from the claims and the abstract, whose wordings are herewith made part of this description by way of reference thereto, the following descriptions of preferred embodiments of the invention, and from the figures, which depict:

FIG. 1 a partially sectioned view of a plumbing fixture having an end of a line inserted therein;

FIG. 2 a sectioned view, corresponding to that of FIG. 1, of a second embodiment;

FIG. 3 a sectioned view, corresponding to that of FIGS. 1 and 2, of another embodiment;

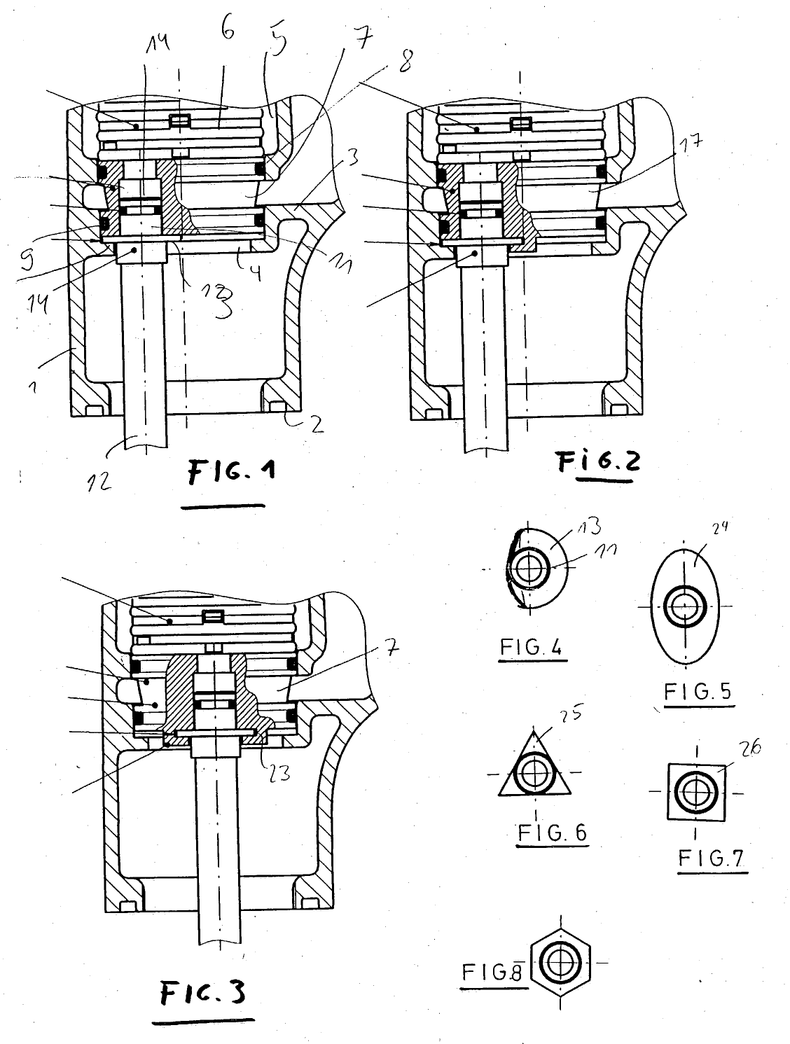

FIGS. 4-8 top views of the end of a line having a latching flange;

FIG. 9 a sectioned view of an end of a single line in an adapter;

FIG. 10 a sectioned view, corresponding to that of FIG. 9, of another embodiment;

FIG. 11 an enlarged top view of a plug-in bushing;

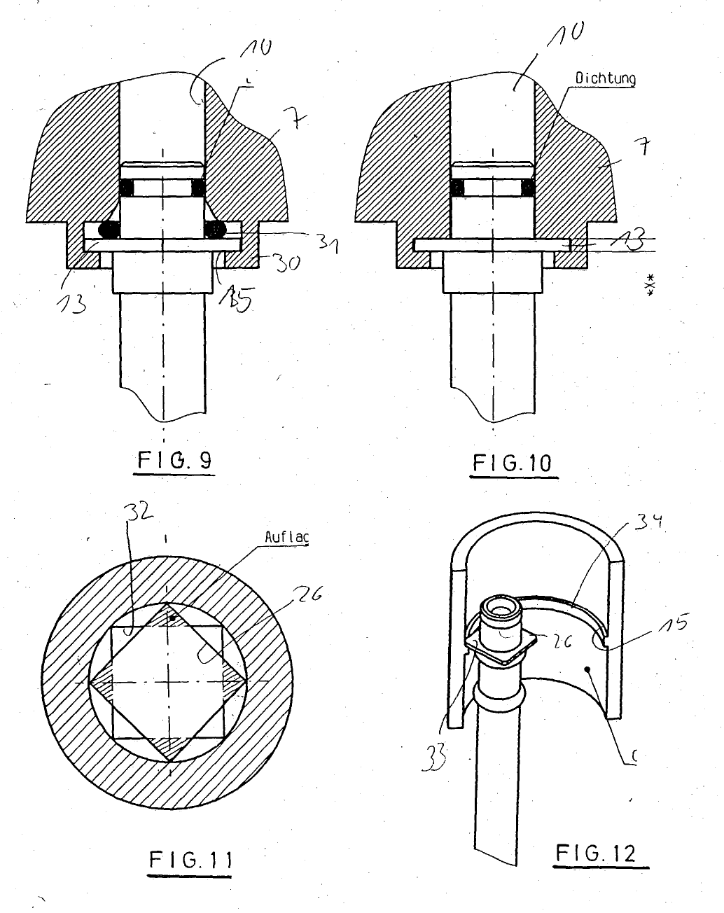

FIG. 12 a perspective view of one means for clamping a flange;

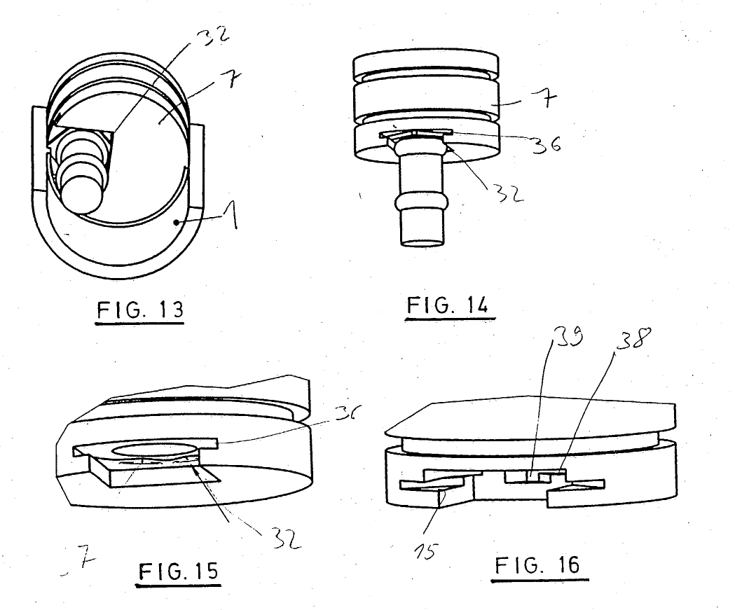

FIG. 13 a view, corresponding to that of FIG. 12, showing an adapter arranged in the housing of the plumbing fixture;

FIG. 14 a side view of the adapter shown in FIG. 13;

FIG. 15 an enlarged view of the opening used for creating the undercut;

FIG. 16 a view, corresponding to that of FIG. 15, of another embodiment.

FIG. 1 depicts a sectioned view of the lower section of a plumbing fixture, namely, a housing 1 having a planar seating surface 2. A base 3 having an aperture 4 is arranged inside the housing. A chamber 5 for accommodating a mixer cartridge 6 is formed above the base having the aperture 4. In the case of the example shown, providing the connection between the base 3 of the housing and the mixer cartridge 6 is assumed by an adapter element 7, which is shown partially sectioned in FIG. 1. An encircling seal 8 seals the joint between the adapter element 7 and the chamber 5 for accommodating the mixer cartridge 6. Another seal 9, which is also an encircling seal, seals the joint between the adapter and the base 3. The purpose of the adapter element is connecting the water lines entering the inlet end and, if necessary, also the water lines exiting the outlet end, to the hardware housed in the mixer cartridge 6.

A stepped bore 10, whose section having the larger diameter faces downward, i.e., opens toward the inlet end, is arranged in the adapter element. The end 11 of a line 12 is inserted into this cylindrical opening 10 forming a plug-in bushing. A flange 13 that, in the case of the example shown, protrudes laterally beyond the end 11 of the line all around its circumference, is located at a distance from the end 11 of the line. The flange 13 is held in place on the end 11 of the line by a short bushing 14. The line 12 may, for example, be either a rigid copper line or a flexible hose. However, the hoses that are used for this purpose are not inflexible enough to prevent them from twisting over the full extents of their visible lengths.

Another sealing ring seals the free end of the line to the wall of the plug-in bushing 10.

In the inserted position shown, the flange 13 rests on a step in the housing of the plumbing fixture that forms an undercut 15. Even though only one side of the flange rests thereon when in this position withdrawal of the line 12 through the length of the nipple 11 ahead of the flange is reliably prevented. In the case of the embodiment shown in FIG. 1, the undercut 15 thus lies ahead of the plug-in bushing 10, which has a cylindrical inner surface, i.e., exerts no clamping function of its own.

The shape of the flange 13 shown in FIG. 4 may serve as an example of the shape of the flange 13 shown in FIG. 1. From FIG. 4, it may be seen that the right half of the flange 13 has a circular shape extending laterally beyond the end of the line, while its left side is flattened to the extent that it is flush with the outer wall of the end of the line. Inserting such a flange, together with the line 12, into the plumbing fixture 1 shown in FIG. 1 from below yields the sectioned view shown in FIG. 1. Rotating the flange 13 counterclockwise through 90° will disengage the flange from the undercut 15 in order to allow the push-on hose to be withdrawn. In order to rotate the flange, it will be sufficient to grasp line 12 or the hose themselves. Although other tools may be used, no other tools are required.

FIG. 12 depicts an embodiment that differs only slightly from that shown in FIG. 1, where the adapter element 7 now has a somewhat different shape. The undercut 15 is now formed both by a section of the plumbing fixture and partly within the adapter element 7, which has been achieved by forming a slot extending partway around the circumference of the inner wall of the plug-in bushing 10. In the case of this embodiment, the flange 13 is held in place on all sides, since the undercut also extends all the way around the circumference of the plug-in connector.

In the case of yet another embodiment that is shown in FIG. 3, the undercut is formed entirely by a slot 23 in the adapter element 7 in order that the housing of the plumbing fixture will play no role in this embodiment.

In the following, several potential shapes for flanges will be presented, based on FIGS. 4-8. The asymmetric, single-sided, flange 13 shown in FIG. 4 has already been mentioned in conjunction with FIG. 1. An asymmetric flange of this type may well have benefits, since it may, under some circumstances, simplify feeding the end of the line into the plug-in bushing 10.

FIG. 5 depicts a flange 24 that has an elongated oval shape. In the case of this flange as well, similar to the case for the embodiment shown in FIG. 4, rotating it through 90° will turn it to the latched position.

In FIG. 6, the flange has a triangular shape such that it must be rotated through 60° in order to insert it.

FIG. 7 depicts the flange in the form of a square that thus must be rotated through 45° in order bring it to the latched position.

The flange shown in FIG. 8 is in the form of a regular hexagon.

Let us now turn to the enlarged views shown in FIGS. 9 and 10. FIG. 9 depicts a section through the end of the plug-in bushing 10 showing how its opening gradually expands, like a funnel. Formed immediately ahead of this expanding, funnel-shaped opening is a sort of “cage” 30 on the undercut 15 that serves as a seat for the flange 13. An O-ring 31 fabricated from an elastomeric material that forces the nipple on the hose up against the undercut 15 along the axial direction holds the flange in place. Of course, this O-ring also serves as a seal. A sealing ring 31 having such elastic properties may be used to securely fasten the end of the line in the plug-in bushing.

FIG. 10 depicts a similar sort of embodiment, where, however, the flange 13 is wedged into the associated undercut, which may be achieved by means of starting chamfers or similar that exert a firm interference-fit that presses of the flange 13 against the planar surfaces of the undercut.

FIG. 11 schematically depicts how a square flange 26 latches into a square aperture 32 in a plug-in bushing. In order to insert the flange into the aperture, the square flange 26 (cf. FIG. 7) is aligned on the square aperture 32 such that it coincides therewith. The flange may then be slid through the aperture 32. Finally, the end of the hose is rotated through 45° in either direction, preferably in the clockwise direction. One corner of the square flange will then be centered between two corners of the square openings. The hatched surfaces shown in FIG. 11 secure the end of the line in the axial direction.

FIG. 12 depicts a perspective view illustrating how a corner 33 of the flange 26 is held in place on the far side of a rib 34 forming the undercut 15. FIG. 13 depicts a similar perspective drawing, where the square flange 26 has now been inserted into the square aperture 32 in the adapter element 7, whereby it will now also be held in place on the far side of the rib 34.

FIG. 14 depicts a perspective side view of an adapter element 7 having the pair of grooves for accommodating the sealing rings 8, 9 that have been previously mentioned in relation to FIG. 1. The adapter element 7 has a wide notch 36 on its circumference that is situated above a narrow notch that is open at the bottom and forms the aperture 32. Since both the notch 36 and the aperture 32 are open on both ends, the adapter element may be manufactured using a simple process. The notch 36 forms the undercut, and the notch beneath it forms the aperture 32 for inserting the flange. When the adapter element 7 is inserted into the plumbing fixture 1, the ends of both the aperture 32 and the notch 36 will close. The representations shown in FIGS. 13 and 14 have been chosen such that they allow more easily perceiving how the flange is held in place in the plug-in bushing. On initial installation, installation may also proceed in this manner. The point of the invention is that the hose or line 12 may be released and withdrawn from the assembled plumbing fixture by rotating it. Of course, it may also be installed by rotating it in the opposite direction.

FIG. 15 depicts the lateral break of the notch 36 that has just been mentioned on an even larger scale. A pair of lugs 37 that produce a sort of “wedging” of the inserted end of the line when the flange has been rotated to the right position have been formed on the rear face of the wall opposite the notch 36. The force acting on the flange that latches the flange in place may also be exerted in the transverse direction, since, in the cases of the embodiments shown, the terminal section of the line protruding above the flange will be able to find a lateral mating surface in the plug-in bushing.

In the case of the embodiment shown in FIG. 16, the notch forming the undercut 15 incorporates a ramp 38 and a recess 39 behind the ramp such that a sort of bayonet connector will be formed, which will also lead to a secure clamping of the end of the line in the plumbing fixture, without, however, preventing withdrawal of the end of the line.

1. A plug-in connector for plumbing fixtures having a plug-in bushing associated to the plumbing fixture, an undercut associated to the plug-in bushing, a line to be connected to the plumbing fixture, and a flange attached near the end of the line that has a perimeter having other than a circular shape and that may be brought into engagement with the undercut by rotating it, after the line end has been pushed into the plug-in bushing.

2. A plug-in connector according to claim 1, wherein the undercut is configured such that the line, along with the flange, may be rotated to the extent that withdrawal of the line from the plug-in bushing will be prevented.

3. A plug-in connector according to claim 1, wherein the undercut is configured such that the undercut and flange will be wedged together when the line is rotated.

4. A plug-in connector according to claim 1, wherein the flange is configured such that the undercut and flange will be wedged together when the line is rotated.

5. A plug-in connector according to claim 1, wherein the undercut and flange jointly form a bayonet connector.

6. A plug-in connector according to claim 1, wherein the undercut is formed on one side of the plug-in bushing only.

7. A plug-in connector according to claim 1, wherein the undercut is formed around the end of the line.

8. A plug-in connector according to claim 1, wherein the undercut is at least partially formed ahead of the plug-in bushing.

9. A plug-in connector according to claim 1, wherein the plug-in bushing is formed in an adapter element, situated between a mixer cartridge and the housing of the plumbing fixture.

10. A plug-in connector according to claim 1, wherein the undercut is formed in the housing of the plumbing fixture.

11. A plug-in connector according to claim 1, wherein the undercut is formed in the adapter element.

12. A plug-in connector according to claim 1, wherein the ends of the undercut in the adapter element are open and may be closed by inserting the adapter into the housing of the plumbing fixture.

13. A plug-in connector according to claim 1, wherein the ends of the plug-in bushing in the adapter element are open and may be closed by inserting the adapter into the housing of the plumbing fixture.

14. A plug-in connector according to claim 1, wherein the flange is located at a distance from the free end of the line.

15. A plug-in connector according to claim 1, wherein an axial force acting on the flange forces it up against the undercut in order to clamp the end of the line in the plug-in bushing.

16. A plug-in connector according to claim 15, wherein an elastic element is provided in order to exert the axial force acting on the flange.

17. A plug-in connector according to claim 16, wherein the elastic element is formed by an O-Ring.
